(19) United States
(12) Patent Application Publication
(10) Pub. No.: US 2019/0378153 A1
(43) Pub. Date: Dec. 12, 2019

(54) Attention Token Digital Asset Rewards

(71) Applicant: Brave Software, Inc., San Francisco, CA (US)

(72) Inventors: Brendan Eich, Santa Clara, CA (US); Brian Johnson, Scottsdale, AZ (US); Marshall Rose, Sacramento, CA (US); Nejc Zdovc, Ljubecna (SI)

(21) Appl. No.: 16/436,869

(22) Filed: Jun. 10, 2019

Related U.S. Application Data
(60) Provisional application No. 62/683,012, filed on Jun. 10, 2018.
(60) Provisional application No. 62/683,000, filed on Jun. 10, 2018.
(60) Provisional application No. 62/683,001, filed on Jun. 10, 2018.

(51) Int. Cl. G06Q 30/02; G06Q 20/36; G06Q 50/00

(52) U.S. Cl. CPC G06Q 30/0215; G06Q 50/01; G06Q 20/367

(57) ABSTRACT

An attention application includes a digital asset wallet. The attention application can estimate the attention a user has spent such as on media content created by a publisher or ads sent by an advertiser. The attention application can pay an amount of the digital asset to the publishers based on the attention spent by the user or receive a payment of the digital asset if the user devoted sufficient attention to a paying advertiser. The user of the attention application can

### CROSS-REFERENCE TO RELATED APPLICATIONS

This application is a non-provisional application claiming priority benefit of U.S. Provisional Patent Application Nos. 62/683,000, 62/683,001, and 62/683,012, entitled “Attention Metrics for Attention Applications,” “Attention Application User Classification Privacy,” and “Attention Token Digital Asset Rewards,” respectively, all filed Jun. 10, 2018 and incorporated by reference herein.

### BACKGROUND OF THE INVENTION

Attention applications present media content to a user. The media content may include text, websites, audio, video, etc., and the attention application may run on computer hardware such as a smartphone, tablet, gaming system, desktop computer, etc. When users consume media content on an attention application, especially when browsing the World Wide Web on a browser, parties other than the media content publisher conduct surveillance on the user. Trackers, for example, may follow the user around the web and collect aspects of the user's browsing history and patterns that are unrelated to the media content being viewed or searched by the user. Media content publishers may decide to purchase user classification profiles from trackers to improve performance of their advertisements. This arrangement directs the majority of the revenue in the system to trackers and ad-tech entities, and away from content publishers and users. Privacy of the users is infringed by trackers and other techniques such as fingerprinting and intrusive (and sometimes abusive) advertisements degrade the user experience.

Accordingly, there is a need for attention application digital asset rewards to pay content producers for media content and users of attention applications for viewing advertisements.

### BRIEF DESCRIPTION OF THE SEVERAL VIEWS OF THE DRAWINGS

FIG. 1 is a diagram of attention token reward payments among an attention application, media content creators, and other participants in the system.

FIG. 2 is a diagram of automatic digital asset attention token rewards.

FIG. 3 is a diagram of a digital asset attention token rewards cycle.

FIG. 4 is a diagram of digital asset attention token rewards to third-party content-producing platform accounts on media platforms.

FIG. 5 is a diagram of a microblogger feed with digital asset attention token reward button on third-party content contributions.

FIG. 6 is a diagram of a digital asset attention token tip screen on a media platform with third-party content contributions.

FIG. 7 is a diagram of a streaming video platform with third-party content contributions with comments and attention token reward buttons associated therewith.

FIG. 8 is a diagram of online forums with third-party content contributions and attention token reward buttons associated therewith.

FIG. 9 is a diagram of an attention token rewards dashboard on an attention application.

FIG. 10 is a diagram of an attention application receiving attention tokens from a User Growth Pool (UGP).

FIG. 11 is a block diagram of an attention token rewards system.

FIG. 12 is a workflow for making attention token rewards.

FIG. 13 is a flowchart of a method of attention token rewards.

FIG. 14 is a flowchart of a method of processing attention token rewards among participants in an attention economy.

FIG. 15 is a system diagram of a device that may be useful in implementing the disclosure herein.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

Users of attention applications, especially Web browsers, tend to leak private information as they consume media content. Web browsing in particular exposes users to scrutiny from trackers who assemble and sell classification and interest profiles of users to advertisers and media publishers. Users are often not aware that trackers follow them all around the web, even on media publishing sites the users believe are unrelated to the trackers. Certain pieces of information that should be private to the user relating to sensitive information is exposed to anonymous stranger such as the query log, browsing history, sharing activity, purchase history, etc. Even when a user makes a direct request to a website without using a search engine, a DNS query can reveal the user's visit to the website without the user's permission. The user experience may feel creepy due to targeted ads but the experience also delivers poorly targeted ads since not even the most ubiquitous trackers see all of a user's activity. Some websites, such as news sites, typically host dozens of trackers that slow page load times and devour the user's bandwidth, which can be particularly expensive on mobile networks.

In this disclosure, the term “digital asset” is meant to include a scarce and transferable asset, particularly on a blockchain. Some blockchains (e.g., the Ethereum network) allow for contract execution that can be used to create and manage the supply of digital assets normally referred to as “tokens.” Other blockchains may have other systems for determining supply of the digital assets (e.g., a declining coin emissions schedule). The term “transferring” the digital asset can refer to the broadcasting of a cryptographically signed transaction to a network of the blockchain to update a shared ledger to transfer a payment of the digital asset from an address controlled by the payor to an address controlled by a payee. “Transferring” can also mean herein that a party controlling private cryptographic keys needed to spend or transfer the digital asset has assigned ownership of the digital asset from the payor to the payee without necessarily confirmation on a shared ledger of the transaction. The terms “digital asset attention token” and “attention token” are used interchangeably herein.

An attention token is a type of digital asset that is deemed to have a value related to the attention of a human user of an attention application. A system of incentives can encourage participants (e.g., advertisers, publishers, and consumers) to acquire attention tokens and make rewards payments via the attention tokens. In one implementation, an attention token creation event generates a supply of attention tokens that can be apportioned among various recipients. One recipient of tokens may be a User Growth Pool (UGP) to hold attention tokens on behalf of future users and distribute attention token grants as part of a new user onboarding process.

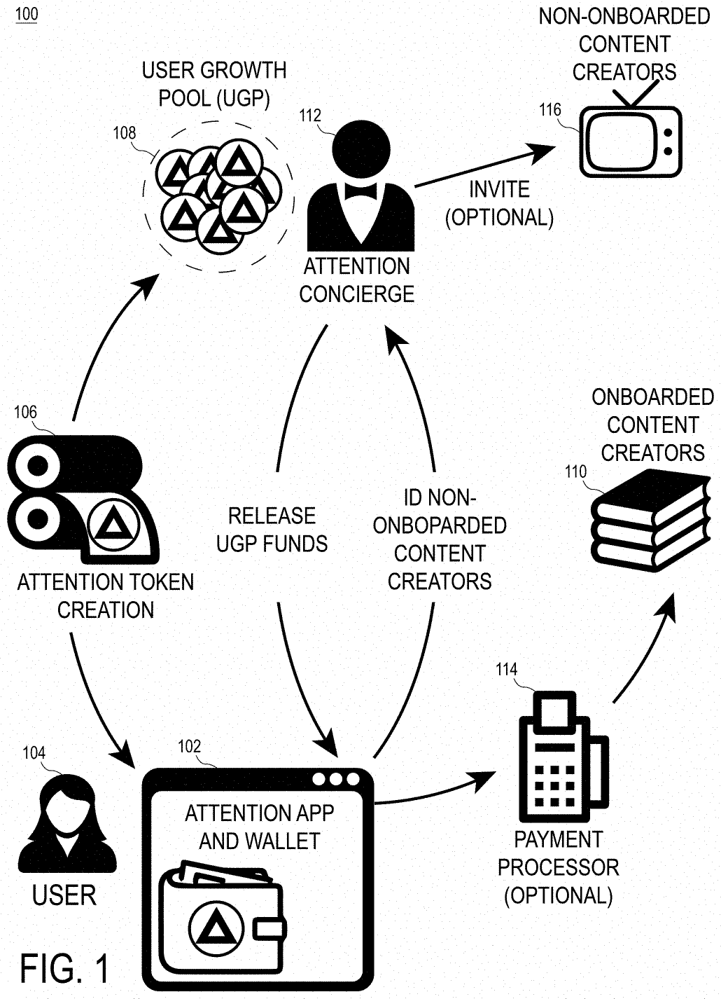

FIG. 1 is a diagram of attention token reward payments among an attention application 102, onboarded media content creators 110, and other participants in the system 100. An attention token creation event 106 may mint a supply of attention tokens for use in the system 100. If the system 100 is to assign a monetary value to the attention tokens, then a level of scarcity of new attention tokens may be desirable. The attention token creation event 106 may therefore create only a limited supply of attention tokens. The limited supply may be a one-time creation event, an ongoing event wherein new attention tokens are created according to a schedule, and/or the attention tokens may be minted on demand. A dedicated token creation participant (not shown in FIG. 1) may have control of attention token supply. In other implementations, another participant in the system 100 may control attention token supply, such as the attention concierge 112. In some implementations, a UGP 108 receives a number of tokens to be disbursed after an initial token creation event to future participants in the system 100.

An attention application 102 includes a digital asset wallet for holding attention tokens. There are several different ways the digital asset wallet can hold attention tokens. In one implementation, the digital asset wallet is initialized in a process that includes creation of a restore seed. One type of restore seed is a list of words chosen from a set of words that can deterministically generate payment addresses (public keys or values derived therefrom) and spending keys (private keys) for any number of digital assets (e.g., BIP39 restore seeds for bitcoin) including the attention tokens and/or a base digital asset needed to interact with the attention tokens (e.g., the ether digital asset if attention tokens are spendable by interacting with a smart contract on the Ethereum network).

When the digital asset wallet has a payment address or set of payment addressees, these addresses can be used to uniquely identify the wallet. Blockchains often include an address space large enough that no two users will ever generate the same payment address, assuming sufficient entropy was available for the wallet address creation. The restore seed may be used to create sets of payment address on multiple blockchains. Since the likelihood of address collision is low to nonexistent, any of the payment addresses may be used to uniquely identify the attention application to other participants in the system 100. Identification in this manner has privacy advantages because the user 104 is not asked to supply potentially personally identifying information such as a legal name, username, phone number, email address, etc. that could reveal the real identity of the user 104 or be used to track the user 104 and link actions by the user in the system 100 to other activities (e.g., connect a web browsing history of the user 104 with a purchase history). The user 104 thus participates anonymously in a sense in the system 100. Avoiding the need to enter potentially identifying information provides a level of privacy and security when web browsing that is usually unavailable to most users, especially when financial transactions are involved.

As the user 104 consumes media content on the attention application 102, the attention application may collect indicia of attention paid by the user 104 to certain media content consumed on the attention application 102. The indicia of attention may be collected automatically (e.g., measurement of what % of total time the user spent on a particular website garners a proportional amount of a particular autocontribution) and/or collected via a signal from the user (e.g., clicking an attention token rewards tip button for a one-time and/or recurring tip reward).

Based on the collected indicia of user attention, the digital asset wallet may make rewards payments in the attention token to the onboarded content creators 110. “Onboarded” in this disclosure refers to a content creator that has signaled a willingness or agreement to accept attention tokens. A list of onboarded content creators may be maintained by a third party (e.g., the attention concierge 112) and transmitted to the attention application 102 for comparison to a list of websites visited by the user 104 which garnered indicia of attention. Whether a rewards payment is an automatic payment or a tip payment, the digital asset wallet executes a transfer of the attention tokens to the onboarded content creators 110. If the digital asset wallet is a traditional asset wallet that has spending capability (e.g., ability to sign blockchain transactions with a private key corresponding to a public key having funds on a shared ledger), then the digital asset wallet can initiate a transfer of funds via the blockchain network to the onboarded content creators 110, provided the onboarded content creators 110 have published payment addresses.

In other implementations, the digital asset wallet on the attention application 102 does not sign rewards payment transactions with a private key itself. Instead, attention tokens are held on behalf of the user 104 with a third party such as the payment processor 114. The attention application 102 may display payment addresses to the user 104 for which private spending keys are actually held by the payment processor 114 and not the attention application 102. When digital asset funds are sent to these payment addresses, the payment processor 114 will credit the balance to the attention application 102. Thereafter, when the attention application 102 wishes to make an attention token payment to the onboarded content creators 110, the attention application 102 may simply sign a message with its private keys to the payment processor 114 requesting funds transfer. The payment processor 114 can then internally on its own private ledger move the funds to an account associated with the onboarded content creators 110, who may then withdraw funds directly from the payment processor 114 as desired.

An attention concierge 112 performs functions in the system 100 by communicating with the attention application 102. One type of communication with the attention application 102 may be to send lists of onboarded content creators 110 such that the attention application knows whether media content to which the user 104 has paid attention are eligible for attention token rewards payments. The attention concierge 112 may promote the system 100 and receive and validate signals from non-onboarded content creators 116 that they wish to become onboarded.

Another type of interaction between the attention concierge 112 and the attention application 102 is to receive lists of websites and/or media content creators to which the user 104 has paid attention. For content creators that are not onboarded (e.g., have not signaled a willingness to accept attention tokens), the concierge 112 may invite the non-onboarded content creators 116 to join and participate in the system 100. An attention concierge 112 may aggregate attention indicia from a number of attention applications, thus providing the non-onboarded content creators with an estimate of an amount of attention tokens potentially available if the non-onboarded content creators decide to participate in the system 100.

Another type of interaction between the attention concierge 112 and the attention application 102 is the management of releasing funds from the UGP. In an implementation, the attention concierge 112 possesses signing keys to one or more addresses capable of minting and/or burning attention tokens (e.g., whitelisted addresses on an Ethereum smart contract). In other implementations, the attention token supply is managed in other ways (e.g., a predetermined issuance schedule). The attention concierge 112 can disburse UGP funds based on criteria of its choosing. Since attention applications are uniquely identified by digital asset wallet addresses and not on other identifying information regarding the user 104, the attention concierge 112 can disburse UGP funds without compromising privacy of the user 104 as would normally be the case for financial or asset transactions.

Disbursement of UGP funds, like rewards payments to the onboarded content creators 110, may be direct (e.g., a confirmed blockchain transaction) and/or indirect through a payment processor 114. In the case of UGP funds deposited with the payment processor 114 and credited to a digital asset wallet on the attention application 102, these funds may be transferred to an onboarded content creator 110 by internal transfer at the payment processor, thus avoiding potential problems with blockchain network congestion, transaction fees, and other costs of transacting on-chain. Disbursal of UGP funds can be contingent on the user 104 of the attention application 102 to provide a proof of humanity (e.g., completing a challenge designed to detect non-human attempt to receive attention tokens).

If the attention concierge 112 receives lists of non-onboarded content creators 116 from attention applications, then the attention concierge 112 may send the non-onboarded content creators an invitation message to become onboarded to the system 100 and “claim” the attention tokens. The invitation message may include an estimate by the attention concierge 112 of the value of attention tokens that could be claimed by a non-onboarded content creator 116. On the other hand, revealing lists of visited content creators to an attention concierge 112 is detrimental to the overall privacy of the user 104. The user 104 may not wish to reveal to any party, inside or outside of the system 100, information regarding which media content creators receive attention on the attention application 102. Accordingly, an invitation message from the attention concierge 112 to non-onboarded content creators may not be made.

On a regular time period (e.g., monthly), the attention application executes a transfer of a digital asset from a wallet of the attention application to publishers and advertisers according to the fraction of total attention captured by each respective advertiser/publisher. In some implementations, a user of the attention application determines a fixed periodic (e.g., monthly) transfer amount to be divided among the content producers according to attention spent. There can be a minimum amount of attention to trigger inclusion in the periodic digital asset transfer.

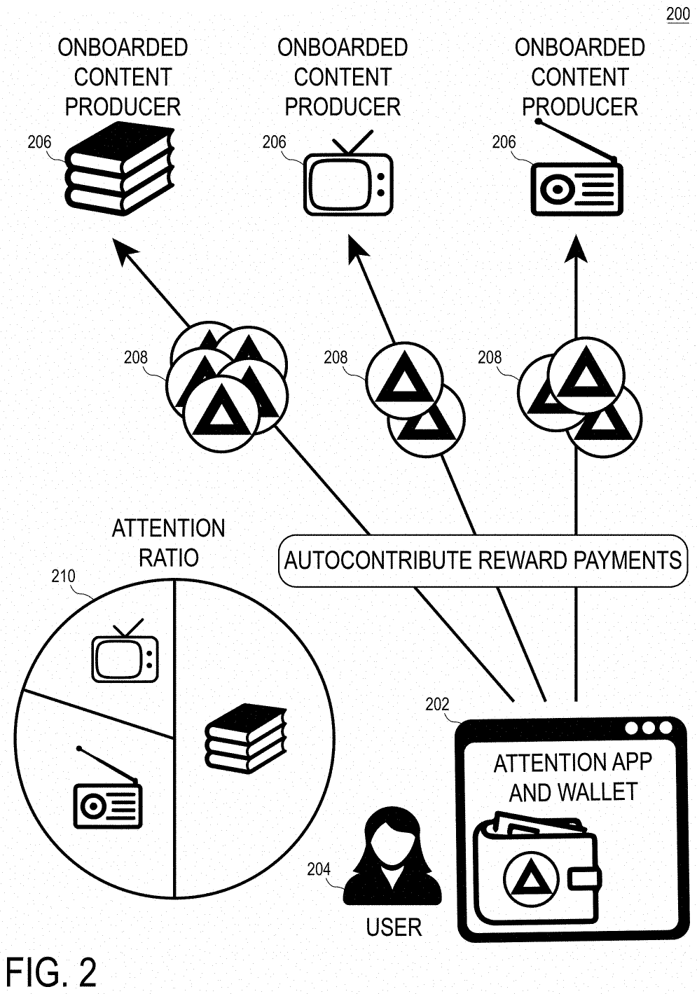

FIG. 2 is a diagram 200 of automatic attention token digital asset rewards. In the example illustrated in FIG. 2, an attention application 202 includes a digital asset wallet holding attention tokens. The attention application 202 measures indicia of attention when displaying media content to the user 204 to yield an attention ratio 210. In the implementation illustrated in FIG. 2 attention token reward payments are made automatically (“autocontribute”) to the onboarded content producers 206 according to the attention ratio 210. In implementations, the autocontribute rewards payments to the onboarded content producers 206 are made on a periodic basis (e.g., monthly).

Contributions made in the system 200 respect privacy of the user of the attention application 202 in several ways. The publisher is not able to correlate publisher visits with contributions. The attention application can reconcile contributions and publisher visits only on an aggregated basis such that individual visits are not tied to particular web site visits.

Under a typical web browsing workload, it is likely that the attention application 202 will display a long list of web sites and domains to the user 204 during the period between autocontribute attention token reward payment to the onboarded content producers 206. As such, money content creators who received attention from the user 204 would be assigned what amounts to “dust” levels of the token. If a threshold is set for a minimum autocontribute attention token reward payment, then handful of the most popular sites may dominate contributions, which is problematic for onboarding new, especially smaller niche, content producers. Systems of contributions other than strictly proportional contributions (e.g., if Site A has twice as many publisher views as Site B for a particular contribution, then Site A should receive twice as much of that contribution as Site B) may therefore be preferable.

One way of determining contributions is to use “statistical voting.” Statistical voting involves the attention application 202 making a contribution and associating it with a unique viewingID. The viewingID is used to create a credential with a Viewing registrar, and is given the identities of one or more voting registrars that will authorize the viewingID to cast a ballot. Each ballot contains a single publisher identity.

As with fractional voting, the client calculates the relative weights of publisher views for each site. Then, for each of the voting registrars that it is authorized to use, the attention application 202 selects a publisher identity using an unpredictable, but weighted, algorithm. For example, if Site A has twice as many publisher views as Site B for a particular contribution, it will not necessarily garner twice as much of the contribution.

To carry out statistical voting, a registrar returns its public key, allowing the attention application 202 to construct a credentialing request. Then the registrar returns intermediate results allowing the client to construct a credential for a string representing its ID, along with the identities of one or more voting surveyors. Returning the public key and returning intermediate results may be done on a periodic cycle, such as one every 30 days.

Next, the surveyor returns intermediate results to allow the attention application 202 to construct an authorization proof that is also anonymous. The attention application 202 then generates an authorization token that proves that the report came from an authorized user without providing any information about the viewingID. On success, the surveyor adds a vote for the publisher to the associated contribution surveyor. Anonymous proofs of the type disclosed in U.S. patent application Ser. No. 16/435,808 entitled “Attention Metric for Attention Applications” filed Jun. 10, 2019, the content of which is incorporated by reference herein, may be used as one example.

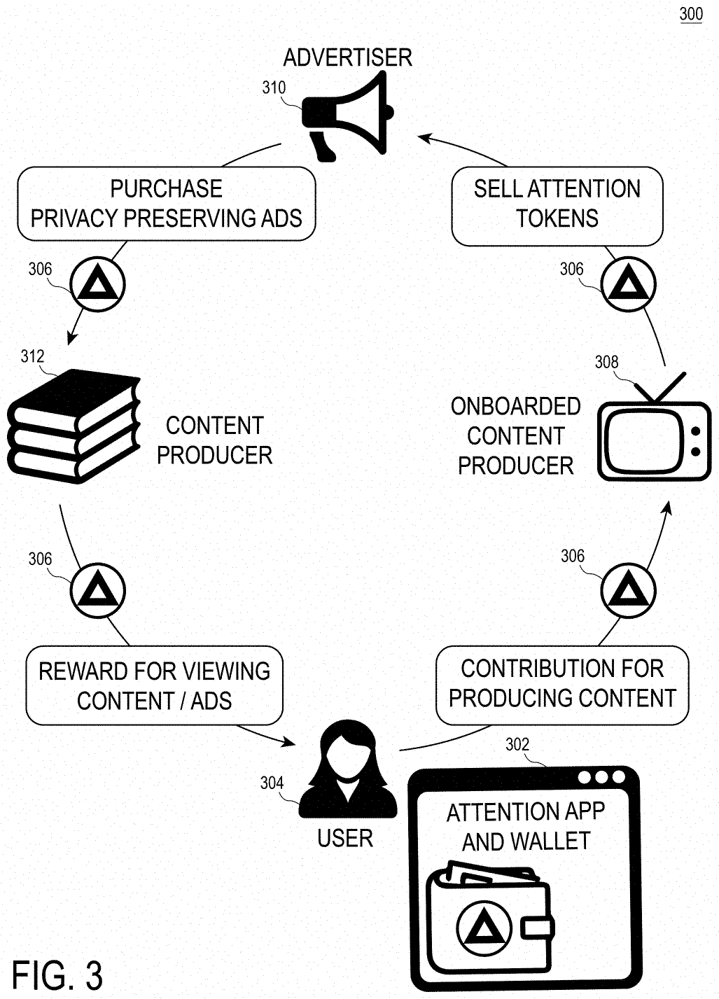

FIG. 3 is a diagram of a digital asset attention token rewards cycle 300. A user of an attention application 302 obtains attention tokens 306 for storing in the digital asset wallet of the attention application 302. The user rewards the attention tokens 306 to an onboarded content producer 308 for producing content that garnered attention of the user 304 as measured by the attention application 302. If the attention tokens are deemed to have value and the content producer 308 does not wish to spend them directly, the attention tokens may be sold to an advertiser 310, thus bringing attention revenue to the onboarded content producer 308.

In implementations, the only type of ads allowed into the ad catalog are “privacy preserving ads.” Privacy preserving ads have features that safeguard the privacy of the user of the attention application and often also improve performance due to faster content loading times. A privacy preserving ad prevents access to any personally identifiable information (e.g., the user's real name, address, email, payments and/or purchase history, browser query log, browser history, contact list, which ads have been viewed, which advertising market segments the user has been classified in, previously used cryptocurrency wallet addresses, credit card numbers, any information protected under the EU General Data Protection Regulation, etc.).

The advertiser 310 may spend the attention tokens 306 by placing ads with a content producer (e.g., via a catalog of ads sent to attention application 302 for local matching). In implementations, the attention tokens 306 are apportioned between the content producer 312 and the user 304 as a reward for attention of the user 304.

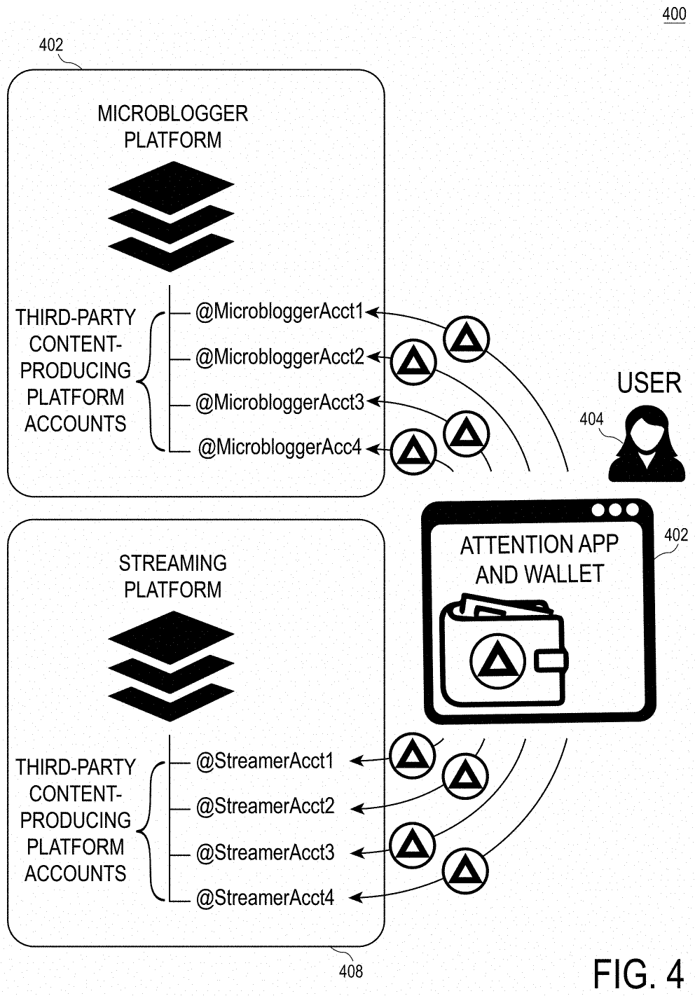

FIG. 4 is a diagram 400 of digital asset attention token rewards to third-party content-producing platform accounts on media platforms. A media platform may include, for example, a microblogger platform 402 wherein third-parties create accounts and contribute content in the form of posts to which other users may subscribe. The third-parties are independent of the platform itself other than their using an account on the platform to post content. If the attention application does not distinguish between the third-party account posting the content and the microblogging platform 402 itself, then attention token rewards may not be paid to the original creators of the content, the third-party account holders. Accordingly, the attention application 402 may treat the third-party accounts as individual content publishers and thus the recipients of the attention tokens.

Implementations of the system 400 include crediting a dwell time on a homepage or feed of the third-party content producing platform accounts as attention paid to the third-party. Other implementations include rewards payments according to interactions between the user 404 and the third-party content (e.g., liking a post, sharing a post, commenting on a post, etc.). Rewards may be contingent on other factors as well, such as the likelihood of a user to interact with a particular third-party content producing account, such as indications that the third-party account is a favorite of the user 404 (e.g., the user interacts with a high percentage of the content created by the third-party account on the platform). In some implementations, a tip button is available to credit a one-time or recurring tip to the third-party content producing platform.

Streaming platform 408 is another example of a third-party content producing platform. Other examples include social media network sites, music and audio content sites, video sites, online forums, comment sections on blogs, newspapers, and magazine sites, etc. As with the microblogger platform 402, digital asset rewards flow to the third-party account holders themselves and not to the streaming platform for attention paid to content created by the third-parties and not the platform 408 itself.

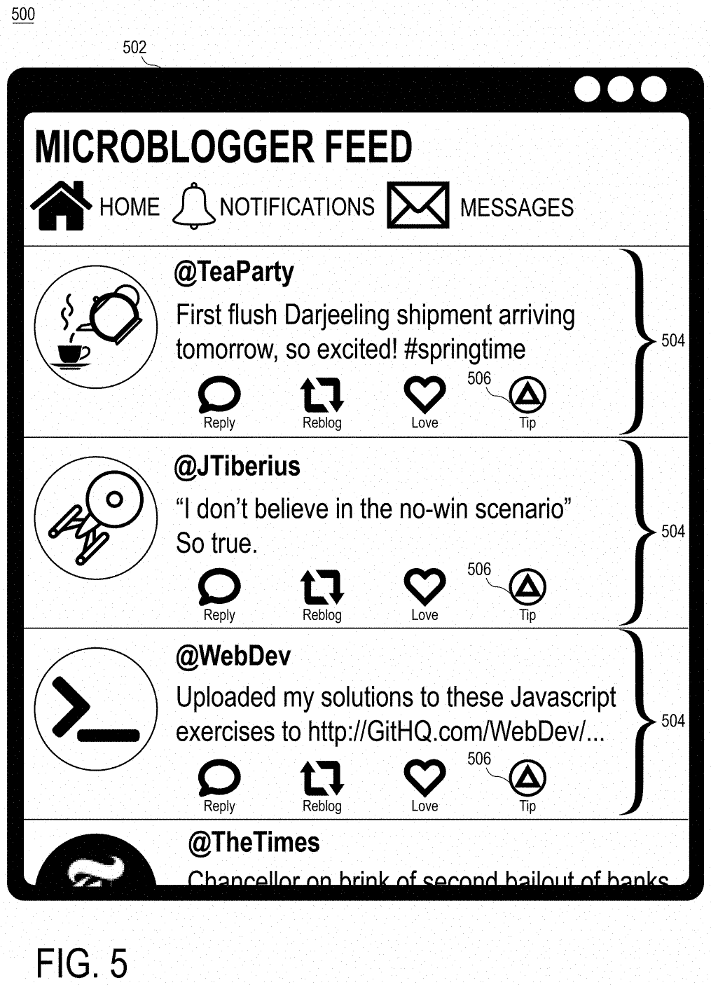

FIG. 5 is a diagram 500 of a microblogger feed with digital asset attention token reward button on third-party content contributions. The various third-party content contributions 504 (e.g., microblog posts) are each associated with several action buttons (e.g., reply, reblog, love, and tip 506) as displayed on the attention application 502. The third-party content is confined to an area 504 of the feed 500. Inside the area 504 is a tip button 506. Clicking the tip button 506 will lead the digital asset wallet of the attention application 502 to reward a digital asset token to the account that posted the content 504 and not to the operator of the microblogging platform.

Other buttons in the content area 504 can also trigger a digital asset reward payment. For example, a user of the attention application 502 can select a preference for every reblog and/or love click apportions an amount of digital asset reward payment to the account that created the content in the area 504. In some implementations, the tip button rewards the third-party content creator by adding the third-party content creator to a list of content creators who share a reward payment (e.g., a periodic reward payment apportioned according to the fractional number of tips compared to all tips made by the user of the attention application 502 during the reward period, according to a “statistical voting” scheme, a fixed amount per tip, etc.). Clicking on a third-party user account name to request a feed consisting only of content contributions by the third-party account may also be an action that is credited with a reward apportionment to the third-party content creator.

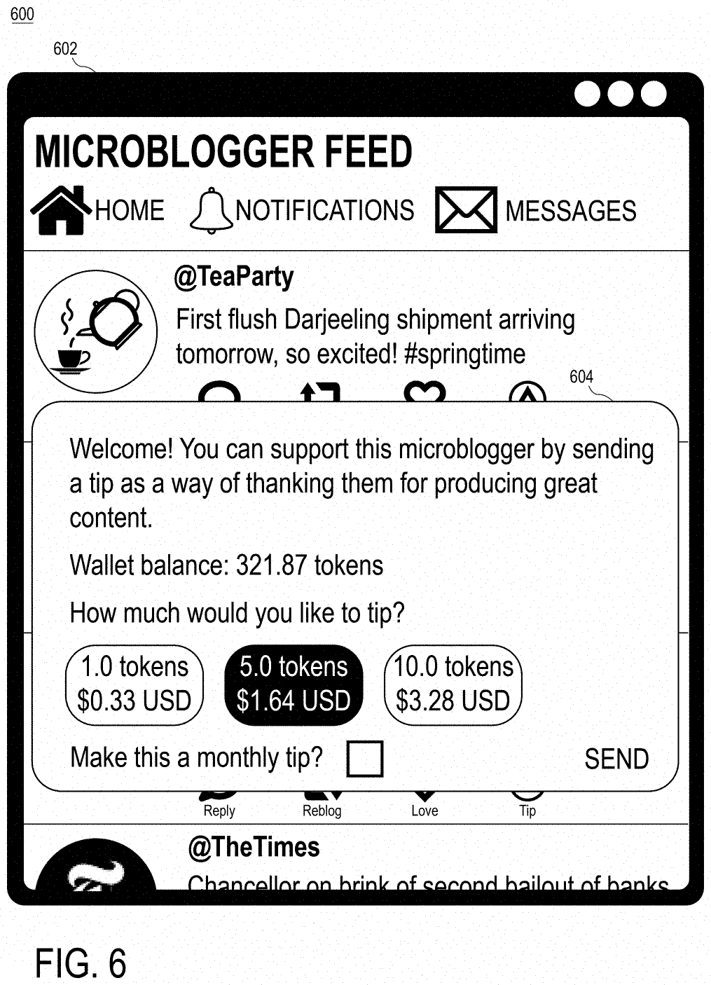

FIG. 6 is a diagram of a digital asset attention token tip screen 600 on a media platform with third-party content contributions. The window 604 is an example of selection of an tip amount to the third-party content creator that can be a one-time tip or a recurring tip based on the selection of the user of the attention application 602.

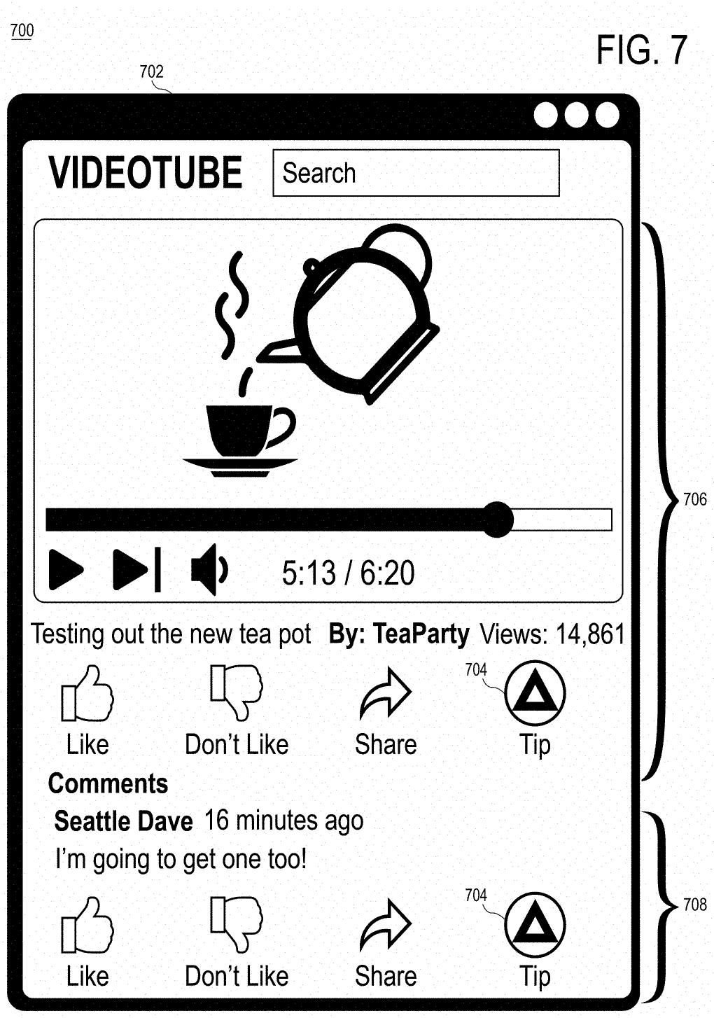

FIG. 7 is a diagram 700 of a streaming video platform with third-party content contributions with comments 708 and attention token reward buttons 704 associated therewith. The streaming video platform consists of content added by third-party account holders, such as the content in the area 706 in FIG. 7. There are buttons associated with the content area 706 including a tip button 704. Clicking on the tip button 704 by a user of the attention application 702 apportions a digital asset reward tip to the third-party content creator. In implementations, the digital asset reward tip may be a one-time tip, a recurring tip, an addition of the third-party content creator to a list of content creators that will share a periodic reward contribution (e.g., proportionally, according to “statistical voting,” etc.).

The diagram 700 also includes an area 708 for content contributions from third-parties other than the third-party who created the content in area 706. Typically area 708 represents comments sections wherein many participants on the streaming platform may contribute comments. There are also buttons to interact with the comments, including a tip button 704 that works the same way at the tip button 704 associated with area 706.

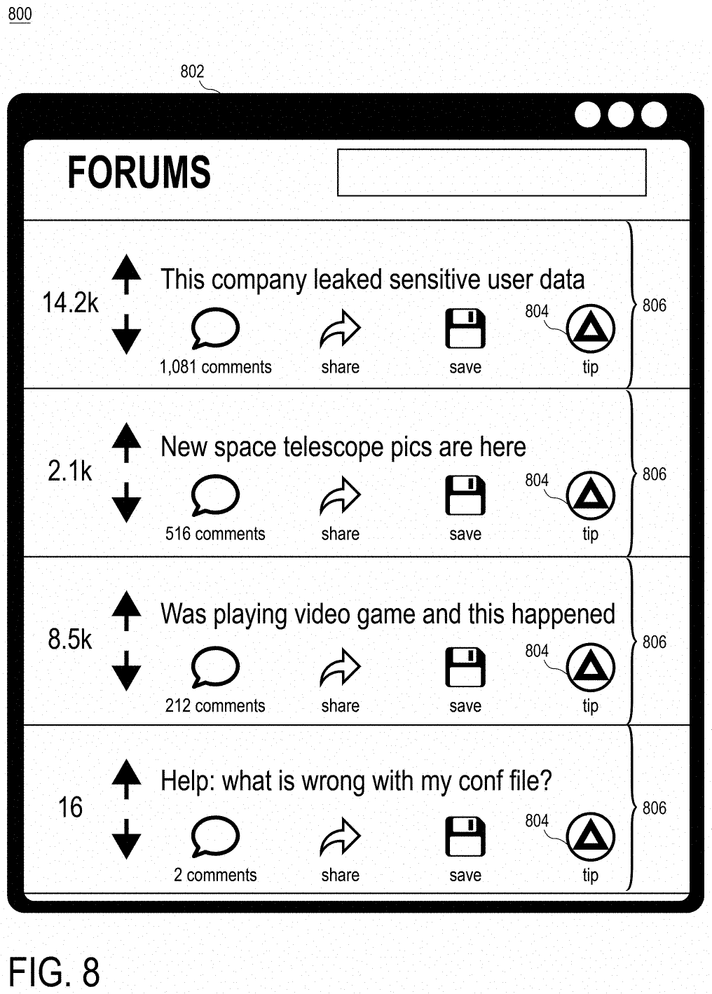

FIG. 8 is a diagram of online forums 800 with third-party content contributions 806 and attention token reward buttons 804 associated therewith. The online forum platform consists of content added by third-party account holders, such as the content in the areas 806 in FIG. 8. There are buttons associated with the content area 806 including a tip button 804. Clicking on the tip button 804 by a user of the attention application 802 apportions a digital asset reward tip to the third-party content creator. In implementations, the digital asset reward tip may be a one-time tip, a recurring tip, an addition of the third-party content creator to a list of content creators that will share a periodic reward contribution (e.g., proportionally, according to a “statistical voting” scheme, etc.). Tip buttons 804 are also available for other third-party content in the form of comments on the content in areas 806.

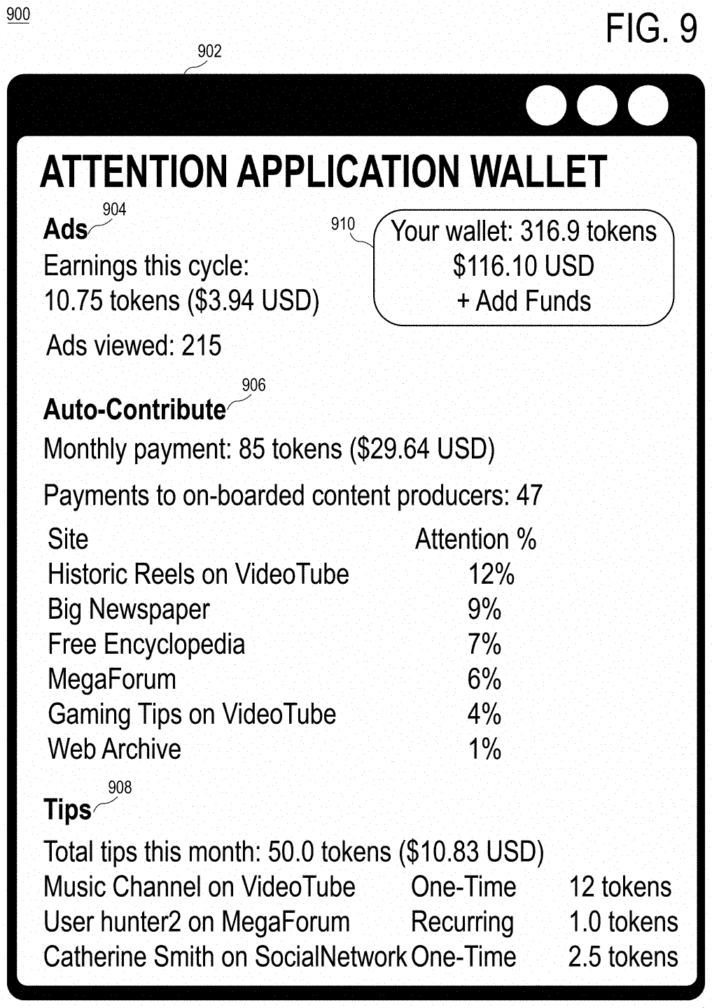

FIG. 9 is a diagram of an attention token rewards dashboard 900 on an attention application. The dashboard includes an ad section 904 that displays rewards earned by the user of the attention application 902 by viewing ads on the attention application 902 (e.g., by viewing privacy-protecting ads).

An auto-contribute section 906 displays a periodic monthly contribution of 85 attention tokens to 47 onboarded content producers apportioned according to an attention percentage. The attention percentage may be proportionally represented (e.g., 12% of the user's total attention to onboarded content producers garners 12% of the monthly autocontribute reward payment). The attention percentage could also be calculated in a way that is not proportional to favor smaller content producers and to reduce the odds of a privacy breach that could connect a reward payment to the user of the attention application if it was known where the user of the attention application had directed attention during the reward payment contribution period. A tips section 908 displays the total number of tips made during a period and whether the tips were one-time or recurring.

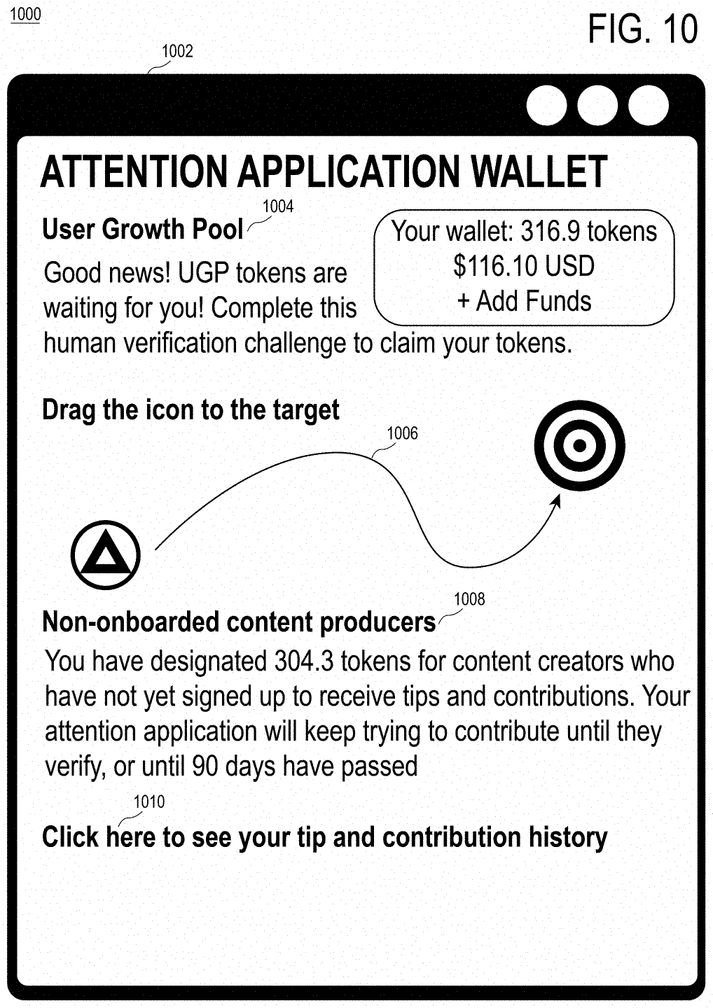

FIG. 10 is a diagram 1000 of an attention application 1002 receiving attention tokens from a User Growth Pool (UGP). The UGP message 1004 informs the user that that attention application 1002 is eligible to receive UGP funds (e.g., based on registration of the digital asset wallet address of the attention application 1002). The attention application 1002 includes a human challenge to test whether the user of the attention application 1002 is responding programmatically to the request or whether the user is likely to be a real human.

Another aspect of the diagram 1000 is the notice regarding non-onboarded content producers 1008. Likely at least some fraction of the user's attention will be directed to content producers who have not signaled a willingness to accept attention tokens. Rewards apportioned to such non-onboarded content creators can be kept in the attention application 1002 for a period of time (e.g., 90 days) until it is returned to the digital asset collateral wallet for reward payment distribution to other, onboarded content producers. Notice 1010 displays a tipping history of the user of the attention application 1002.

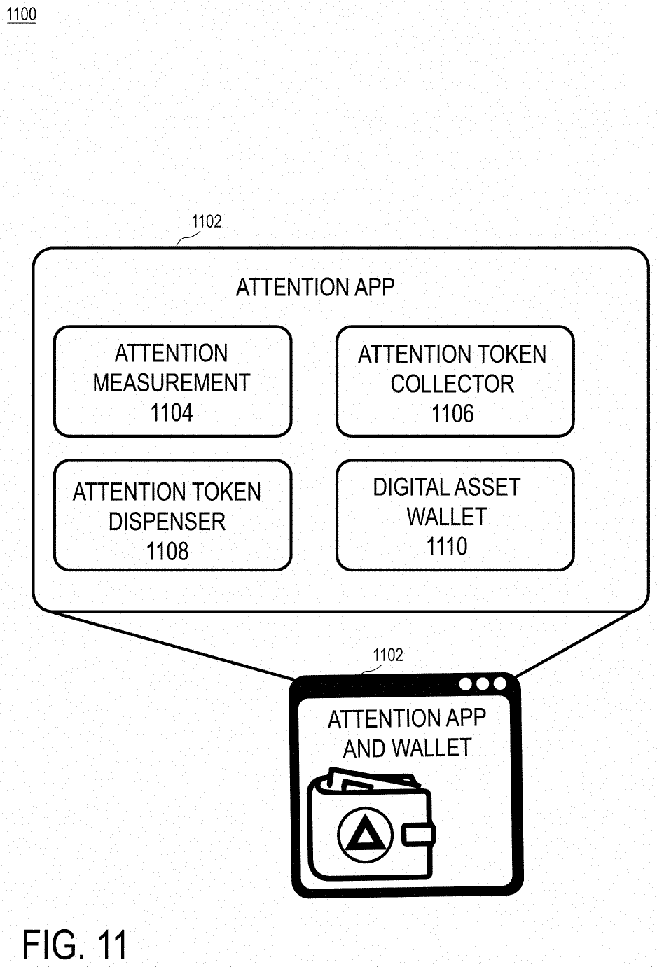

FIG. 11 is a block diagram of an attention token rewards system 1100 The system 1100 includes an attention application 1102 with several components for carrying out the functions described herein. One components of the attention application 1102 is an attention measurement component 1104. The attention measurement includes an attention metric for measuring attention paid by the user to media content displayed on the attention application 1102 and for apportioning digital asset reward payments thereon. Digital asset reward payments may be according to a percentage of total attention paid by the user to onboarded content producer, one-time tips, recurring tips, and any combination thereof.

Another component of the attention application 1102 is the attention token collector 1106. The attention token collected may receive tokens into the digital asset wallet from external sources. One potential external source is attention tokens acquired by the user and sent to the attention application 1102 such as from an online digital asset exchange. Another potential source of attention tokens for the attention token collector 1106 are disbursements from the UGP. Yet another potential source of attention tokens for the attention token collector 1106 are rewards payments for watching ad with rewards associated therewith.

Another component of the attention application 1102 is the attention token dispenser 1108. The attention token dispenser 1108 can distribute attention tokens from the digital asset wallet 1110 to content creators via autopayments, tips, and/or any combination thereof. The attention token dispenser may be “triggered” to make the digital asset reward payments by another party, such as an attention manager that monitors the success of ad campaigns and the status of attention credited to the attention application 1102. A digital asset wallet 1110 can be used to generate payment addresses that are unique to the attention application 1102 (e.g., a blockchain payment address), sign messages proving attention originated with the attention application 1102, and sign transactions moving digital assets out of the attention application 1102 (e.g., broadcasting a transaction to a network of a blockchain on which a digital asset is transmitted from sender addresses to recipient addresses).

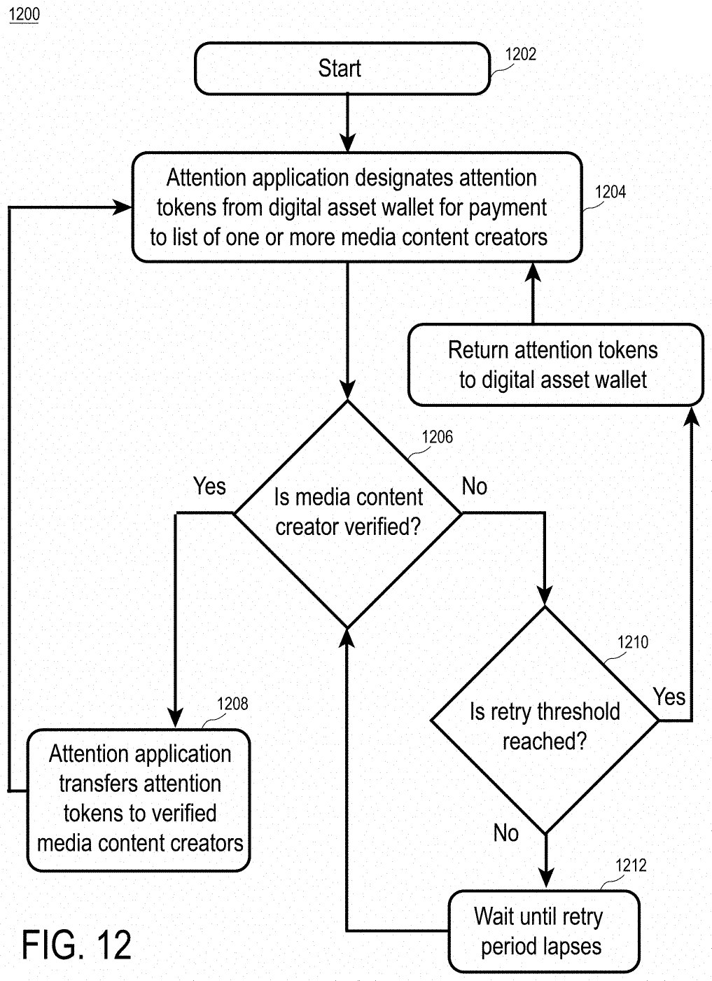

FIG. 12 is a workflow 1200 for making attention token rewards to onboarded content creators. After a start block 1202, an attention application designates attention tokens from a digital asset wallet for payment to a list of one or more media content creators. In implementations, the list of one or more media content creators is based on attention paid by the user of the attention application to media content originating with the one or more media content creators.

At block 1206 the workflow 1200 determines whether each media content creator on the list is verified (also referred to herein as being onboarded). One way to become verified is to signal a willingness to accept attention tokens in return for content that users of the attention application paid attention to. If a media content creator on the list is verified, then the attention application transfers attention tokens to the verified publisher at 1208 and the workflow returns to step 1204 if there are not more content creators on the list. If the next media content creator on the list is not verified at 1206, then the workflow 1200 proceeds to block 1210. Block 1210 determines whether a retry threshold is reached. An example retry threshold to pay attention token rewards to a content creator is 90 days from the initial apportionment of tokens to the content creator. If the retry threshold has not been reached at 1210, then the workflow 1200 proceeds to wait at block 1212 for a period of time (e.g., a period of time less than the retry threshold) and return to block 1206. In this way, tokens apportioned to non-onboarded content creators will be recycled to onboarded content creators, likely encouraging more content creators to become onboarded and avoiding redirection of the attention tokens to a third party or any entity outside the attention application 1202.

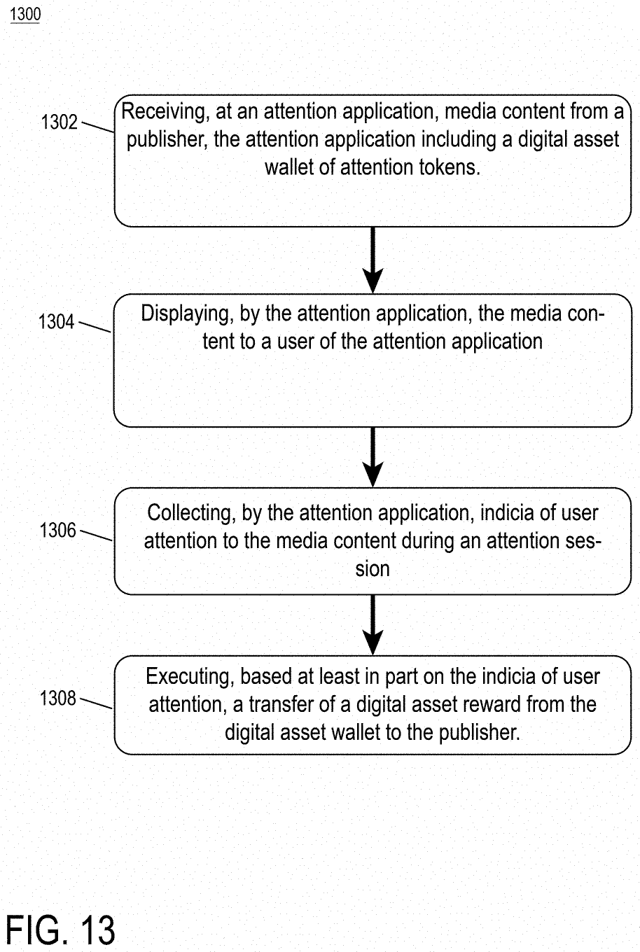

FIG. 13 is a flowchart of a method 1300 of attention token rewards. A receiving operation 1302 receives, at an attention application, media content from a publisher, the attention application including a wallet of attention tokens. A displaying operation 1304 displays, by the attention application, the media content to a user of the attention application. A collecting operation 1306 collects, by the attention application, indicia of user attention to the media content during an attention session. The attention session may be a periodic timeframe during which attention metrics are collected and digital asset rewards payments are made by the attention application (e.g., every 30 days). An executing operation 1308 executed, based at least in part on the indicia of user attention, a transfer of digital asset rewards from the digital asset wallet to the publisher.

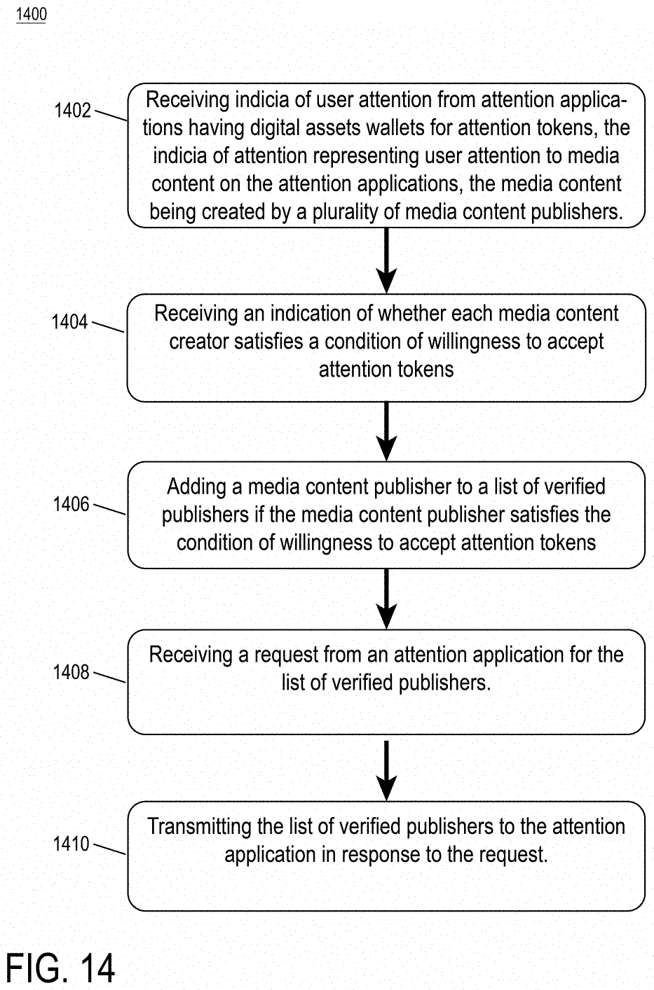

FIG. 14 is a flowchart of a method 1400 of processing attention token rewards among participants in an attention economy. A receiving operation 1402 receives indicia of user attention from attention application having digital asset wallets for attention tokens, the indicia of attention representing user attention to media content on the attention application, the media content being created by a plurality of media content publishers. A receiving operation 1404 receives an indication of whether each media content creator satisfies a condition of willingness to accept attention tokens (e.g., a willingness to be a “verified” or “onboarded” publisher). An adding operation 1406 adds a media content publisher to a list of verified publishers if the media content publisher satisfies the condition of willingness to accept attention tokens.

A receiving operation 1408 receives a request form an attention application for the list of verified publishers. The receiving operation 1408 may be in response to client requests from attention applications that are obscured to limit risk of personally identifiable information or user information from becoming associated with the attention application. For example, a polling time of the request received by operation 1408 can be varied to obscure geographical location of the attention application. Other techniques include routing the request via a third party and/or not logging request metadata such as HTTP header fields, IP addresses, etc. A transmitting operation 1410 transmits the list of verified publishers to the attention application in response to the request.

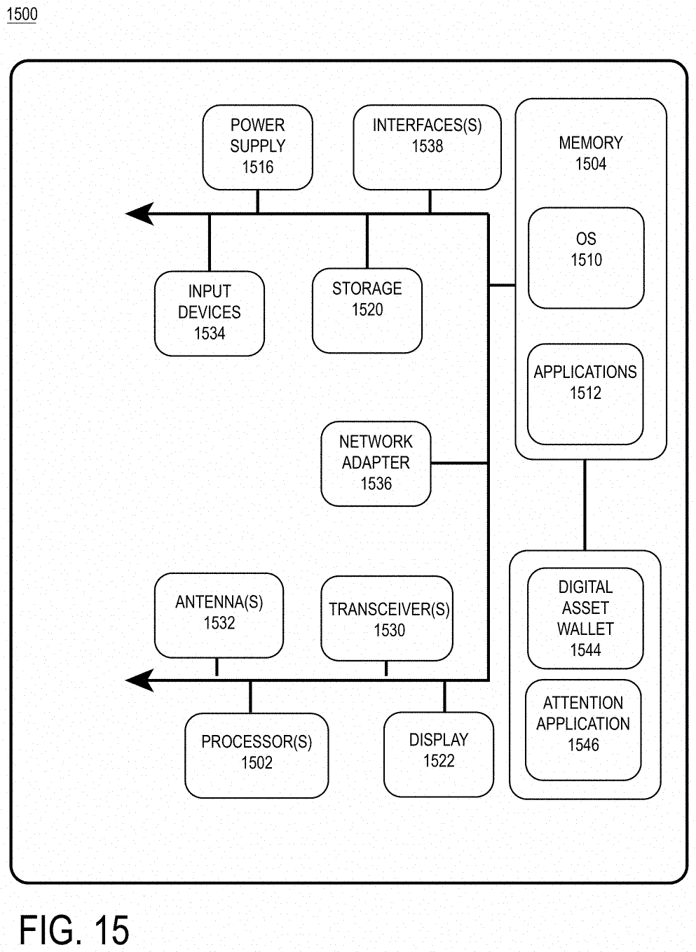

FIG. 15 is a system diagram of a device 1500 that may be useful in implementing the disclosure herein. FIG. 15 illustrates an example system (labeled as a processing system 1500) that may be useful in implementing the described technology. The processing system 1500 may be a client device, such as a smart device, connected device, Internet of Things (IoT) device, laptop, mobile device, desktop, tablet, or a server/cloud device. The processing system 1500 includes one or more processor(s) 1502, and a memory 1504. The memory 1504 generally includes both volatile memory (e.g., RAM) and non-volatile memory (e.g., flash memory). An operating system 1510 resided in the memory 1504 and is executed by the processor 1502.

One or more application programs 1512 modules or segments, such as digital asset wallet 1544 and attention application 1546 are loaded in the memory 1504 and/or storage 1520 and executed by the processor 1502. In some implementations, the digital asset wallet 1544 is stored in read-only memory (ROM) 1514 or write once, read many (WORM) memory. Data such as extrinsic event data sources may be stored in the memory 1504 or storage 1520 and may be retrievable by the processor 1502 for use by digital asset wallet 1544 and the blockchain manager 1546, etc. The storage 1520 may be local to the processing system 1500 or may be remote and communicatively connected to the processing system 1500 and may include another server. The storage 1520 may store resources that are requestable by client devices (not shown). The storage 1520 may include secure storage such as one or more platform configuration registers (PCR) managed by one or more trusted platform modules (TPMs), which may be implemented in a chip or by the trusted execution environment (TEE).

The processing system 1500 includes a power supply 1516, which is powered by one or more batteries or other power sources and which provides power to other components of the processing system 1500. The power supply 1516 may also be connected to an external power source that overrides or recharges the built-in batteries or other power sources.

The processing system 1500 may include one or more communication transceivers 1530 which may be connected to one or more antenna(s) 1532 to provide network connectivity (e.g., mobile phone network, Wi-Fi®, Bluetooth®, etc.) to one or more other servers and/or client devices (e.g., mobile devices, desktop computers, or laptop computers). The processing system 1500 may further include a network adapter 1536, which is a type of communication device. The processing system 1500 may use the network adapter 1536 and any other types of communication devices for establishing connections over a wide-area network (WAN) or local area network (LAN). It should be appreciated that the network connections shown are exemplary and that other communications devices and means for establishing a communications link between the processing system 1500 and other devices may be used.

The processing system 1500 may include one or more input devices 1534 such that a user may enter commands and information (e.g., a keyboard or mouse). Input devices 1534 may further include other types of input such as multimodal input, speech input, graffiti input, motion detection, facial recognition, physical fingerprinting, etc. These and other input devices may be coupled to the server by one or more interfaces 1538 such as a serial port interface, parallel port, universal serial bus (USB), etc. The processing system 1500 may further include a display 1522 such as a touch screen display.

The processing system 1500 may include a variety of tangible processor-readable storage media and intangible processor-readable communication signals including in virtual and/or cloud computing environment. Tangible processor-readable storage can be embodied by any available media that can be accessed by the processing system 1500 and includes both volatile and nonvolatile storage media, removable and non-removable storage media. Tangible processor-readable storage media excludes intangible communications signals and includes volatile and nonvolatile, removable and non-removable storage media implemented in any method or technology for storage of information such as processor-readable instructions, data structures, program modules or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information, and which can be accessed by the processing system 1600. In contrast to tangible processor-readable storage media, intangible processor-readable communication signals may embody computer-readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter

1. A method of attention token rewards, the method comprising:
receiving, at an attention application, media content from a publisher, the attention application including a digital asset wallet of attention tokens;
displaying, by the attention application, the media content to a user of the attention application;
collecting, by the attention application, indicia of user attention to the media content during an attention session; and
executing, based at least in part on the indicia of user attention, a transfer of a digital asset reward from the digital asset wallet to the publisher.

2. The method of claim 1, wherein the transfer of the digital asset reward includes a set of payments to publishers, an amount of each payment in the set of payments being based on a fraction of attention of a user of the attention application paid to each publisher.

3. The method of claim 1, wherein the transfer of the digital asset reward from the digital asset wallet includes a one-time tip payment to a publisher.

4. The method of claim 2, wherein the transfer of the digital asset reward from the digital asset wallet is a recurring tip.

5. The method of claim 1, wherein the publisher is a third-party account on a user-content media platform.

6. The method of claim 1, wherein the indicia of user attention to the media content is a social media interaction with the publisher by the user of the attention application.

7. The method of claim 6, wherein the indicia of user attention to the media content is a click on an integrated tip button on a post on a social media platform.

8. The method of claim 6, wherein an amount of the digital asset reward depends on a type of the social media interaction with the publisher by the user of the attention application.

9. The method of claim 5, wherein the indicia of user attention to the media content is a dwell time on the media content.

10. The method of claim 1, wherein the media content includes a toast notification with a hyperlink and the indicia of user attention is a click on the toast notification.

11. A digital asset reward system, the system comprising:
an attention application for displaying media content to a user, the attention application including a digital asset wallet of attention tokens;
an attention token dispenser to distribute attention tokens from the digital asset wallet to media content creators; and
an attention token collector to receive attention tokens into the digital asset wallet based at least in part on attention paid by the user to media content associated with a digital asset reward.

12. The system of claim 11, wherein the media content associated with the digital asset reward is an advertisement.

13. The system of claim 11, wherein the attention token dispenser automatically distributes tokens to the media content creators according to a fraction of total attention paid by the user.

14. The system of claim 11, wherein the attention token dispenser returns attention tokens to the digital asset wallet if the distribution to the media content creator is not successful when the timeout period lapses.

15. The system of claim 11, wherein an attention manager triggers the attention token dispenser to distribute attention tokens to the media content creator.

16. A method of administering an attention economy with a digital asset attention token, the method comprising:
receiving indicia of user attention from attention applications having digital assets wallets for attention tokens, the indicia of attention representing user attention to media content on the attention applications, the media content being created by media content publishers;
receiving an indication of whether each media content creator satisfies a condition of willingness to accept attention tokens;
adding a media content publisher to a list of verified publishers if the media content publisher satisfies the condition of willingness to accept attention tokens;
receiving a request from an attention application for the list of verified publishers; and
transmitting the list of verified publishers to the attention application in response to the request.

17. The method of claim 16, further comprising:
periodically transmitting a notice indicating available attention tokens to the plurality of media content publishers if the willingness to accept attention tokens condition is not satisfied.

18. The method of claim 17, wherein the periodically transmitting operation ends after a timeout period has lapsed, and the available attention tokens are returned to the digital asset wallet of the attention application.

19. The method of claim 16, further comprising:
triggering disbursement of attention tokens from a user growth pool (UGP) to one or more digital asset wallets on attention applications.

20. The method of claim 19, further comprising:
triggering return of at least part of the attention tokens from the one or more digital asset wallets back to the UGP if the attention applications do not satisfy a reward condition with respect to the at least part of the attention tokens.
